(19) United States
(12) Patent Application Publication
(10) Pub. No.: US 2014/0259898 A1
(43) Pub. Date: Sep. 18, 2014

(54) SELECTIVELY ERADICATING PLANTS

(71) Applicant: Stephen Jens, Winchester, MA (US)

(72) Inventor: Stephen Jens, Winchester, MA (US)

(21) Appl. No.: 13/834,116

(22) Filed: Mar. 15, 2013

(51) Int. Cl. A01M 21/02

(52) U.S. Cl. CPC A01M 21/02
USPC 47/1.43

(57) ABSTRACT

A method of selectively eradicating plants includes generating images of multiple plants arranged in a bed using a machine vision system mounted to a platform moving along the bed, determining respective locations of the multiple plants from the generated images, selecting from among the multiple plants one or more target plants to be eradicated, and eradicating the one or more target plants by forcing the one or more target plants into the bed using a plunger moving along the bed.

### TECHNICAL FIELD

This invention relates to selectively eradicating plants, and more particularly to mechanically thinning and/or weeding crops in an automated manner.

### BACKGROUND

Cultivating crops often involves routine thinning and weeding of the crops. Thinning a field of plants can include destroying and/or removing certain plants in order to maintain a desired spacing between remaining plants (e.g., saved plants). Weeding a field of plants can include destroying and/or removing undesired growths located in proximity to the plants. Thinning and weeding are often performed manually using a standard garden tool (e.g., a hoe) to remove a plant or weed, which can be a laborious task. Thinning and weeding may also be performed using chemical treatments (e.g., fertilizers or herbicides) that may be sprayed on the plants and weeds to chemically kill the plants and weeds. Such chemical treatments can require precise application, may be limited in chemical effectiveness, and may be prohibited on certain (e.g., organic) farms. Additionally, manual and chemical thinning and weeding techniques may be associated with significant costs, risks to personnel safety, and risks to food safety.

### SUMMARY

The invention involves a realization that mechanically thinning and weeding plants in an automated manner can increase the precision of a thinning and weeding operation, while eliminating the need to use chemical treatments, eliminating disadvantages associated with such treatments, and reducing costs associated with manual thinning and weeding operations.

One aspect of the invention features a method of selectively eradicating plants, including generating images of multiple plants arranged in a bed using a machine vision system mounted to a platform moving along the bed, determining respective locations of the multiple plants from the generated images, selecting from among the multiple plants one or more target plants to be eradicated, and eradicating the one or more target plants by forcing the one or more target plants into the bed using a plunger moving along the bed.

Another aspect of the invention features a plant eradication system that includes a machine vision system that is configured to generate images of multiple plants arranged in a bed and determine respective locations of the multiple plants while the plant eradication system is moved in a direction along the bed, a controller that is configured to select one or more target plants from among the multiple plants that should be eradicated, the controller being communicably coupled to the machine vision system, and a plunger that is operable to eradicate the one or more target plants by forcing the one or more target plants into the bed as the plant eradication system is moved in the direction along the bed, the plunger being communicably coupled to the controller.

In some embodiments, the machine vision system includes at least one camera that is directed towards the bed and a processor that is operable to analyze the images.

In certain embodiments, the machine vision system includes at least one hood that surrounds the at least one camera.

In some embodiments, the method further includes identifying the multiple plants in the image using a recognition algorithm.

In certain embodiments, the multiple plants include one or more of beets, carrots, lettuce, romaine, onions, parsnips, radishes, rutabagas, spinach, corn, and turnips.

In some embodiments, determining the respective locations of the multiple plants includes analyzing the images using a blog analysis algorithm.

In certain embodiments, selecting the one or more target plants includes comparing the respective locations of the multiple plants to a predetermined spacing.

In some embodiments, the method further includes identifying one or more plants that are positioned within the predetermined spacing as the one or more target plants.

In certain embodiments, eradicating the one or more target plants includes pushing the one or more target plants about ½ inch to about 2 inches into the bed.

In some embodiments, the method further includes cutting the one or more target plants using the plunger.

In certain embodiments, cutting the one or more target plants includes severing one or more of leaves and stems of the one or more target plants.

In some embodiments, the method further includes identifying one or more weeds in the bed using a recognition algorithm.

In certain embodiments, the method further includes cutting the one or more weeds using the plunger and forcing the one or more weeds into the bed using the plunger.

In some embodiments, the method further includes saving desired plants of the multiple plants.

In certain embodiments, saving desired plants includes rotating the plunger around the desired plants.

In some embodiments, the plunger defines one or more gaps sized to surround a desired plant.

In certain embodiments, the plunger is a rotary plunger including a base and multiple teeth that extend from an outer edge of the base.

In some embodiments, the multiple teeth are configured to cut the multiple plants.

In certain embodiments, the plunger is positioned at a height above the bed such that the plunger can push the one or more target plants into the bed as the plunger rotates.

In some embodiments, the base of the plunger defines one or more gaps sized to surround a desired plant.

In certain embodiments, forcing the one or more target plants into the bed includes dragging the plunger along the bed.

In some embodiments, forcing the one or more target plants into the bed includes rotating the plunger as the plunger moves in the direction along the bed.

In certain embodiments, the plunger is movable via a floating frame configured to move vertically as a function of a height of a surface of the bed.

In some embodiments, a vertical adjustment device is mounted to the floating frame, the vertical adjustment device supporting the plunger.

In certain embodiments, forcing the one or more target plants into the bed includes controlling a rotatory motor to rotate the plunger.

In some embodiments, prior to forcing the one or more target plants into the bed, the plunger is moved in a lateral direction by an actuator configured to translate the plunger.

In certain embodiments, the images are generated, the respective locations of the multiple plants are determined, the one or more target plants are selected, and the one or more target plants are eradicated, while the platform moves at a constant speed along the bed.

In some embodiments, the controller is configured to control the plunger via one or more of a rotary motor and an actuator.

In certain embodiments, the plunger is operable to push the one or more target plants about ½ inch to about 2 inches into the bed.

In some embodiments, the plunger is configured to cut the one or more target plants.

In certain embodiments, the plunger is operable to force one or more weeds into the bed.

In some embodiments, the plant eradication system further includes a floating frame that is configured to move vertically as a function of a height of a surface of the bed.

In certain embodiments, the plant eradication system further includes a vertical adjustment device that is mounted to the floating frame, the vertical adjustment device supporting the plunger.

In some embodiments, the plant eradication system further includes a rotary motor that is communicably coupled to the controller and that is configured to rotate the plunger.

In certain embodiments, the plant eradication system further includes an actuator that is communicably coupled to the controller and that is configured to translate the plunger.

In some embodiments, the plant eradication system further includes an encoder that is communicably coupled to the controller and that is configured to detect a speed at which the plant eradication system moves along the bed.

In certain embodiments, the plant eradication system operates autonomously.

In some embodiments, the plant eradication system is moved along the bed by a tractor.

Embodiments may include one or more of the following advantages. The method and system may be used to mechanically thin and weed undesired plants without damaging desired plants that are to be saved and without using chemical treatments (e.g., fertilizers or herbicides) to remove the undesired plants and weeds. Accordingly, expenses that would otherwise be incurred by purchasing and using chemical treatments and the risks to food safety associated with using such chemical treatments may also be substantially reduced or eliminated. In some examples, the mechanical action performed by the plant eradication system can be particularly beneficial on organic farms, where the use of certain chemical treatments may be prohibited. Furthermore, the automated actions performed by the plant eradication system can alleviate the need to manually identify and remove undesired plants and weeds, thereby saving time and substantially reducing costs.

The details of one or more embodiments of the invention are set forth in the accompanying drawings and the description below. Other features, aspects, and advantages of the invention will be apparent from the description, drawings, and claims.

### BRIEF DESCRIPTION OF THE DRAWINGS

FIG. 1 is a rear perspective view of a thinning and weeding system.

FIG. 2 is a front perspective view of the thinning and weeding system of FIG. 1.

FIG. 3 is a perspective view showing a portion of the thinning and weeding system of FIG. 1, including a plunger defining two gaps, as the plunger eradicates a plant disposed within a bed of plants.

FIG. 4 is a perspective view showing the portion of the thinning and weeding system of

FIG. 3, including the plunger, as the plunger passes over a plant disposed within the bed of plants.

FIG. 5 is a side perspective view showing a portion of the thinning and weeding system of FIG. 1, including a lower frame that supports the plunger of FIG. 3.

FIG. 6 is a rear perspective view showing the portion of the thinning and weeding system of FIG. 5, including the lower frame that supports the plunger of FIG. 3.

FIG. 7 is a flow chart of an example process for thinning and/or weeding crops.

FIG. 8 is a side perspective view showing a portion of a thinning and weeding system, including a plunger defining a single gap.

FIG. 9 is a side perspective view showing a portion of a thinning and weeding system, including a plunger formed as a stake.

FIG. 10 is a perspective view showing a portion of a thinning and weeding system, including a plunger that has wide, spaced apart teeth.

FIG. 11 is a rear perspective view of the thinning and weeding system of FIG. 1, attached to a tractor.

Like reference symbols in the various figures indicate like elements.

### DETAILED DESCRIPTION

A thinning and weeding system for thinning and weeding a variety of crops will be described below. In some embodiments, the thinning and weeding system includes mechanical plungers, a machine vision system, and associated control elements that allow the thinning and weeding system to mechanically remove undesired crops and save desired crops in an automated manner, thereby substantially eliminating a need to use chemical treatments for thinning and weeding the crops. In some examples, the crops may be planted by seed. Example crops that may be thinned and weeded by the thinning and weeding system include beets, carrots, lettuce, romaine, onions, parsnips, radishes, rutabagas, spinach, corn, turnips, and other crops.

FIGS. 1 and 2 display rear and front perspective views, respectively, of a thinning and weeding system 100 that is operable to mechanically thin and weed a variety crops in an automated manner. In some examples, the thinning and weeding system 100 may be configured to operate autonomously, as will be described in more detail below, or may be configured to operate with other vehicles, as will be described in detail with respect to FIG. 11. In the example of FIGS. 1 and 2, the thinning and weeding system 100 is positioned over two spaced apart beds 101 of plants 103 that are located in a field of plants. As illustrated, the plants 103 are arranged in two opposing seed lines 105 along a surface 107 of each bed 101. In some examples, the beds 101 may be spaced about 14 inches to about 22 inches (e.g., 18 inches) apart, depending on the type of plants 103 being cultivated in the beds 101. In some examples, the two opposing seed lines 105 of plants 103 may be spaced about 10 inches to about 14 inches (e.g., 12 inches) apart along the bed 101, depending on the type of plants 103 being cultivated in the beds 101. In some examples, the plants 103 may be spaced about ½ inch to about 2 inches (e.g., 1.75 inches) apart, depending on the type of plants 103 being cultivated.

The thinning and weeding system 100 includes an upper frame 102 supported by four outer wheels 104, two adjacent lower frames 106 that are each supported by two inner wheels 108, and two electrical enclosures 110 mounted to opposing sides of the upper frame 102. The thinning and weeding system 100 further includes a machine vision system 112 that identifies plants 103 and weeds (not shown) that need to be removed from the surfaces 107 of the beds 101 and a programmable logic controller (PLC) that is located within one of the electrical enclosures 110 and that is electrically coupled to the machine vision system 112. The thinning and weeding system 100 additionally includes four plungers 114 that are operable to mechanically remove the identified plants 103 and weeds from the surfaces 107 of the beds 101, four respective motors 116 that are operable to rotate the plungers 114, and an encoder 128 that is operable to detect an angular velocity of the outer wheels 104. Additionally, the thinning and weeding system 100 includes a GPS system (located, for example, within one of the electrical enclosures 110) that provides a field location to the PLC and a generator (not shown) that provides power to the thinning and weeding system 100. The thinning and weeding system 100 further includes high capacity batteries 120 that can power the thinning and weeding system 100 for a limited period of time should the generator malfunction.

The various components of the thinning and weeding system 100 may be powered by, for example, hydraulic or electrical mechanisms that are known to a person skilled in the art. In some examples, the generator converts the hydraulic power to electrical power to provide functionality to the various components of the thinning and weeding system 100.

In some embodiments, the outer wheels 104 have a radius of about 6 inches to about 12 inches (e.g., 9 inches), thereby positioning the upper frame 102 (e.g., and any components mounted to the upper frame 102) of the thinning and weeding system 100 above the level of the field. In some embodiments, the inner wheels 108 have a radius of about 2 inches to about 4 inches (e.g., 3 inches), thereby positioning the lower frames 106 (e.g., and any components mounted to the lower frame 106) of the thinning and weeding system 100 above the surfaces 107 of the beds 101 of plants 103. In this manner, the lower frames 106 are floating frames that have an adjustable height relative to the upper frame 102 such that the thinning and weeding system 100 may adapt to a variable height of the surfaces 107 of the beds 101 of plants 103. As illustrated, the lower frames 106 are attached to opposing sides of the upper frame 102 such that each lower frame 106 is aligned with a respective bed 101 of plants 103. In some embodiments, the lower frame 106 is attached to the upper frame via a four bar linkage mechanism.

Still referring to FIGS. 1 and 2, the machine vision system 112 includes two cameras 122 and two respective hoods 124 that surround the cameras 122. The cameras 122 and the hoods 124 are located along a frontal member 126 of the upper frame 102. The cameras 122 are oriented and positioned to image respective fields of view along the beds 101 of plants 103. In the example embodiment of FIGS. 1 and 2, the cameras 122 and the respective hoods 124 may be spaced apart by about 38 inches to about 44 inches (e.g., 40 inches) along the frontal member 126 of the upper frame 102. The hoods 124 are adapted to block (e.g., reduce the amount of) natural light (e.g., which varies depending on a season, weather, and a time of day) from impinging upon the fields of view.

The cameras 122 include light-emitting diodes (LEDs) and filters for sufficient illumination and desired image characteristics. The cameras 122 may be standard resolution, color video graphics array (VGA) cameras known to a person skilled in the art. For example, the cameras 122 may have a pixel count of 480×640, thereby allowing each camera 122 to capture both seed lines 105 of the respective bed 101 of plants 103 within one field of view (e.g., a 14 inch×18 inch field of view). The camera resolution (e.g., pixel dimension) of such a field of view may be 0.030 inch, which is adequate for identifying individual leaves of the plants 103 and weeds. Processors of the cameras 122 may have a frame processing time of 25 ms and accordingly allow the cameras 122 to acquire images at a rate of 40 fps, which is fast enough to map locations of the plants 103 while the thinning and weeding system 100 moves at a predetermined speed (e.g., 2 ft/sec). Following capture of an image by a camera 122, the image is processed by the processor of the camera 122 and further analyzed according to an algorithm that identifies a location (e.g., using an XY coordinate system) of a plant 103 or weed with respect to the camera 122, as will be described in more detail with respect to FIG. 7.

FIGS. 3 and 4 display perspective views of one of the plungers 114 while removing an undesired plant 103 from the surface 107 of the bed 101 and while saving a desired plant 103, respectively. Two plungers 114 are mounted to each lower frame 106 and are spaced apart such that the plungers 114 are located on opposing sides of the inner wheels 108 of the respective lower frames 106. The plunger 114 is operable to rotate with respect to the lower frame 106. The plunger 114 includes a generally disc-shaped base 115 and multiple teeth 132 that are located along an outer edge of the base 115. A profile of the base 115 defines two opposing gaps 130 that allow desired plants 103 to be saved as the plunger 114 rotates with respect to the lower frame 106 while the thinning and weeding system 100 moves along the beds 101 of plants 103. The gaps 130 extend from a center of the base 115 to the outer edge of the base 115. In some examples, the gaps 130 include an angle of about 20 degrees to about 60 degrees (e.g., 45 degrees).

The teeth 132 are configured to tear and sever roots and leaves of undesired plants 103 as the plunger 114 rotates with respect to the lower frame 106 while the thinning and weeding system 100 moves along the beds 101 of plants 103. The teeth 132 extend within the plane of the base 115 and have a maximum thickness that is substantially less than or about equal to a thickness of the base 115. In some examples, the teeth 132 have a width of about ⅛ inch to about 1 inch (e.g., ½ inch) and a length of about ⅛ inch to about ¾ inch (e.g., ¼ inch). A diameter of the base 115 is generally sized such that the gaps 130 of the plunger 116 may be aligned to surround the desired plants 103 as the plunger 114 rotates along the bed 101 of plants 103. The diameter of the base 115 is further sized such that the teeth 132 may adequately contact an undesired plant 103 to sever the leaves of the undesired plant 103 and such that the plunger 114 may remove the undesired plant 103 from the surface 107 of the bed 101 by forcing (e.g., pushing) the undesired plant 103 into the bed 101 of plants 103. In some embodiments, the base 115 of the plunger 114 has a diameter of about 4 inches to about 14 inches (e.g., 10 inches). In some examples, the plunger 114 may force the undesired plant into the bed 101 by about ½ inch to about 2 inches below the surface 107 of the bed 101. In some embodiments, the base 115 of the plunger 114 has a thickness of about ⅛ inch to about 1 inch (e.g., ½ inch).

Each plunger 114 is rotated in the direction of travel of the thinning and weeding system 100, as indicated by an arrow in FIGS. 3 and 4. The plungers 114 are rotated by the respective motors 116 (e.g., servo-controlled motors) located near centers of the plungers 114, as will be described in more detail with respect to FIG. 7.

FIGS. 5 and 6 display perspective views of two plungers 114 supported by the lower frame 106 of the thinning and weeding system 100. In particular, each plunger is supported by a vertical adjustment device 134 that is mounted to the lower frame 106 and that includes an internal rotating gear mechanism (e.g., a threaded rod). The vertical adjustment device 134 can variably lower the plunger 114 to an appropriate location above the surface 107 of the bed 101 (e.g., to a location such that the outer edge of the plunger 114 extends about ½ inch to about 2 inches below the surface 107 of the bed 101). Additionally, two actuators 136 (e.g., servo drive actuators) are located on each lower frame 106 and are operable to translate the respective plungers 114 in a direction transverse to the seed lines 105 such that the plungers 114 can be aligned with the seed lines 105 as the seed lines 105 vary in position (e.g., lateral position). Accordingly, the plungers 114 may also be positioned to remove weeds located between the opposing seed lines 105. Cam rollers 138 mounted to respective vertical adjustment devices 134 allow the plungers 114 to move smoothly with respect to the lower frames 106 as the thinning and weeding system 100 moves along the beds 101 of plants 103.

In operation, the thinning and weeding system 100 travels along the beds 101 of plants 103. In some examples, the thinning and weeding system 100 travels in an autonomous manner. For example, the thinning and weeding system 100 uses analyses of the images captured by the machine vision system 112, as well as field locations provided by the GPS system, to guide itself along the beds 101 of plants 103. Additionally, the thinning and weeding system 100 uses a field mapping provided by the GPS system to determine when the thinning and weeding system 100 has reached an edge of the field and accordingly when to turn and travel in a different direction.

As the thinning and weeding system 100 travels in the field, wireless communication is maintained over a network between a remote operator and the PLC controller and GPS system so that a status of the thinning and weeding system 100 can be monitored. Example parameters that may be monitored by the remote operator include a field location of the thinning and weeding system 100, a velocity of the thinning and weeding system 100 (e.g., an angular velocity of the outer wheels 104 and the inner wheels 108), a number and location of plants 103 that have been eradicated, a number and location of plants 103 that have been saved, a frame rate of the camera, and a rotational speed of the plunger 114. The remote operator may change any of such parameters by sending a signal that includes a corresponding instruction over the network to the PLC of the thinning and weeding system 100. The PLC may accordingly control the corresponding components of the thinning and weeding system 100. In some examples, the remote operator may monitor and control multiple thinning and weeding systems 100 simultaneously.

In some examples, the thinning and weeding system 100 travels at a speed of about 1 ft/sec to about 3 ft/sec (e.g., about 2 ft/sec). The thinning and weeding system 100 moves with respect to the beds 101 of plants 103 such that each camera 122 images a respective bed 101 of plants 103. Accordingly, the outer wheels 104 rotate along outer edges of the beds 101, and the inner wheels 106 rotate between opposing seed lines 105 of respective beds 101.

FIG. 7 displays a flow chart of an example process 200 that may be implemented to thin and/or weed the beds 101 of plants 103 using, for example, the thinning and weeding system 100. As the thinning and weeding system 100 travels, the cameras 122 generate images of the beds 101 of plants 103 (202). In some examples, the cameras 122 acquire images at a rate of 20 fps to 60 fps (e.g., 40 fps). In some examples, the filters on the cameras 122 may produce an image that highlights the plants 103 and weeds in respective desired colors and shows the soil in grayscale. Once the images are acquired, the images are analyzed using algorithms implemented by the respective camera processors. The images may be analyzed using standard algorithms known to a person skilled in the art, such as a blog analysis. In some examples, the analysis identifies the individual plants 103 and weeds and determines their respective locations (e.g., in an XY coordinate system) (204) with respect to the camera 122. In some examples, the processor may distinguish a plant 103 from a weed using a standard recognition algorithm (e.g., pattern recognition) known to a person skilled in the art. The locations of the identified plants 103 and weeds are sent to the PLC, and the PLC determines which plants 103 (e.g., selects target plants) and weeds should be removed from the surface 107 of the beds 101 (206) and which plants 103 should be saved. In some examples, the PLC determines which plants 103 should be removed and which plants 103 should be saved by comparing the locations of the identified plants 103 to a predetermined spacing between consecutive plants 103. For example, plants 103 located at certain interval locations (e.g., corresponding to the predetermined spacing) may be saved, while plants 103 located within the interval locations may be eradicated. In some examples, the predetermined spacing may be between about 8 inches and about 12 inches (e.g., 10.5 inches), depending on the type of plants 103 being cultivated.

As the thinning and weeding system 100 travels along the beds 101 of plants 103, the encoder 128 monitors an angular speed of the outer wheels 104 and sends this information to the PLC. Using the speed of the outer wheels 104 and the determination of which plants 103 and weeds should be removed and saved, the PLC determines a relationship (e.g., calculates a distance) between the plungers 114 and the plants 103 and weeds. The PLC accordingly controls the motors 116 and the actuators 136 such that the plungers 114 eradicate the undesired plants 103 and weeds (208) by forcing the undesired plants and weeds into the bed 101 and pass over the desired plants 103. For example, the plungers 114 may be rotated (e.g., at a speed that is greater than the speed of the outer wheels 104 of the thinning and weeding system 100) such that the plungers 114 sever leaves from the undesired plants 103 and weeds (e.g., thereby preventing the plants 103 and weeds from growing further) and forces (e.g., pushes) the undesired plants 103 and weeds beneath the surfaces 107 of the beds 101. While the plungers 114 rotate, the gaps 130 of the plungers 114 surround the desired plants 103 such that the desired plants 103 are saved. In some examples, the plungers 114 may not be rotated (e.g., the plungers 114 may have an angular speed of zero), but instead be translated (e.g., dragged) with the movement of the lower frame 106 such that the plungers 114 contact and therefore remove a series of consecutive plants 103. In this manner, the plungers 114 are rotated at a variable angular speed according to which plants 103 and weeds will be removed from the surfaces 107 of the beds 101 and which plants 103 will be saved. In some examples, two opposing plungers 114 may be rotated synchronously along opposing seed lines 105. In some examples, the two opposing plungers 114 may be rotated asynchronously along the opposing seed lines 105.

Accordingly, the thinning and weeding system 100 may be used to mechanically eradicate undesired plants 103 and weeds within the beds 101 of plants 103 without damaging the desired plants 103 that are to be saved and without using chemical treatments (e.g., fertilizers or herbicides) to eradicate the undesired plants 103 and weeds. Accordingly, expenses that would otherwise be incurred by purchasing and using chemical treatments and the risks to food safety associated with using such chemical treatments may also be substantially reduced or eliminated. In some examples, the mechanical action performed by the thinning and weeding system 100 can be particularly beneficial on organic farms, where the use of certain chemical treatments may be prohibited. Furthermore, such automated actions performed by the thinning and weeding system 100 can alleviate the need to manually identify and remove undesired plants 103 and weeds, thereby saving time and substantially reducing costs.

While the thinning and weeding system 100 has been described and illustrated as including two lower frames 106 with respective cameras 122, plungers 114, and other associated components, in some embodiments, a thinning and weeding system may include more than two lower frames with respective cameras, plungers, and other associated components in order to thin and weed multiple respective beds of plants. In such cases, an upper frame of the thinning and weeding system may be sized for appropriate accommodation of the number of lower frames.

While the thinning and weeding system 100 has been described and illustrated as including two plungers 114 located on opposing sides of the inner wheels 108 of the lower frames 106, in some embodiments, a thinning and weeding system may include a different number of plungers 114 (e.g., three plungers 114) in order to thin and weed a bed of plants 103 including more than two seed lines 105 or in order to remove weeds located between the seed lines 105.

While the thinning and weeding system 100 has been described as including the plunger 114 that defines two opposing gaps, in some embodiments, a thinning and weeding system may include a plunger that defines a single gap. For example, FIG. 8 displays a side perspective view of a portion of a thinning and weeding system 300 that includes a plunger 314 that defines a single gap 330. The thinning and weeding system 300 is substantially similar in construction and function to the thinning and weeding system 100, with the exception that the thinning and weeding system 300 includes the plunger 314 instead of the plunger 114. For example, as shown in FIG. 8, the thinning and weeding system 300 includes the lower frames 106, the inner wheels 108, the vertical adjustment devices 134, the motors 116, the actuators 136, and other components of the thinning and weeding system 100 that are not shown.

The plunger 314 is substantially similar in construction and function to the plunger 114, with the exception that a base 315 of the plunger 314 defines the single gap 330 instead of the two opposing gaps 130. Accordingly, the plunger 314 is operable to rotate with respect to the lower frame 106 in order to remove undesired plants 103 from the surfaces 107 of the beds 101 and to save desired plants 103. The gap 330 extends from a center point of the base 315 to an outer edge of the base 315. Additionally, the plunger 314 includes the teeth 132 disposed along the outer edge of the base 315 of the plunger 314. In some examples, the gap 330 includes an angle of about 120 degrees to about 180 degrees (e.g., 150 degrees). The larger angle of the gap 330 (e.g., as compared to the angle of the gaps 130) allows the plunger 314 to pass over (e.g., save) larger plants as compared to the plants 103 that may be saved by the plunger 114 or to pass over a series of consecutive plants 103. Additionally, the larger gap 330 of the plunger 314 requires a greater degree of rotation (e.g., as compared to the rotation of the plunger 114) in order for the plunger 314 to encounter the undesired plants 103. In some examples, the greater degree of rotation of the plunger 314 results in more tearing at the undesired plants 103, which may be appropriate for larger plants or plants 103 that are more difficult to cut.

While the thinning and weeding systems 100, 300 have been described as including the plungers 114, 314 that are generally disc-shaped and define one or more gaps 130, 330, in some embodiments, a thinning and weeding system may include a plunger that is generally formed as a stake. For example, FIG. 9 displays a side perspective view of a portion of a thinning and weeding system 400 that includes a generally elongate-shaped plunger 414. The thinning and weeding system 400 is substantially similar in construction and function to the thinning and weeding systems 100, 300, with the exception that the thinning and weeding system 400 includes the plunger 414 instead of the plunger 114 or the plunger 314. For example, as shown in FIG. 9, the thinning and weeding system 400 includes the lower frame 106, the inner wheels 108, the vertical adjustment devices 134, the motors 116, the actuators 136, and other components of the thinning and weeding system 100 that are not shown.

The plunger 414 is substantially similar in function to the plungers 114, 314, with the exception that the plunger 414 is operable to rotate with respect to the lower frame 106 in order to remove one plant 103 or weed at time from the surface 107 of the bed 101 of plants 103, instead of removing a series of consecutive plants 103. The plunger 414 includes a base 415 and the teeth 132 disposed along opposing outer edges of the base 415. In some examples, the plunger 414 has a length of about 4 inches to about 6 inches (e.g., 5 inches), a width of about ½ inch to about 1.5 inches (e.g., 1 inch), and a thickness of about ⅛ inch to about 1 inch (e.g., ½ inch). In some examples, the configuration of the plunger 414 may be useful for removing occasional weeds that are sparsely located between opposing seeds lines 105.

While the thinning and weeding systems 100, 300, 400 have been described as including the plungers 114, 314, 414 that include the teeth 132 extending in a plane of the plungers 114, 314, 414, in some embodiments, a thinning and weeding system may include a plunger including teeth that extend beyond opposing surfaces of (e.g., out of the plane of) a base of the plunger. For example, FIG. 10 displays a perspective view of a portion of a thinning and weeding system 500 that includes a plunger 514 including oblong-shaped teeth 532 that extend beyond opposing surfaces of a base 515 of the plunger 514. The thinning and weeding system 500 is substantially similar in construction and function to the thinning and weeding systems 100, 300, 400, with the exception that the thinning and weeding system 500 includes the plunger 514 instead of any of the plungers 114, 314, 414. For example, as shown in FIG. 10, the thinning and weeding system 500 includes the lower frame 106, the inner wheels 108, the vertical adjustment devices 134, the motors 116, the actuators 136, and other components of the thinning and weeding system 100 that are not shown.

The plunger 514 is substantially similar in function to the plungers 114, 314, 414 and accordingly is operable to rotate with respect to the lower frame 106 in order to remove plants 103 or weeds from the surface 107 of the bed 101 of plants 103 and save desired plants 103. The base 515 of the plunger 514 is substantially similar in construction to the base 315 of the plunger 314 (e.g., the base 515 defines one gap 530). The teeth 532 are evenly spaced along the outer edge of the base 515 and have a length L that is greater than a thickness of the base 515, such that the teeth 532 extend beyond opposing surfaces of the base 515. In some examples, the teeth 532 have a thickness t of about ⅛ inch to about ½ inch (e.g., ¼ inch), a length L of about 1 inch to about 2 inches (e.g., 1.5 inches), and a width w of about ¼ inch to about 1 inch (e.g., ¾ inch). In some examples, the teeth 532 are spaced about 1 inch to about 2 inches (e.g., about 1.5 inches) apart from one another. In some examples, the thickness of the teeth 532 may be useful for removing plants 103 and weeds that are located along crooked seed lines 105 (e.g., seed lines 105 that vary in lateral position). For example, in such cases, using the plunger 515 (as compared to any of the plungers 114, 314, 414) may require less lateral adjustment of the plunger 515 using the actuator 136 as the thinning and weeding system 500 travels along the beds 101 of plants 103.

While the thinning and weeding system 100 has been described as operating autonomously, in some embodiments, any of the thinning and weeding systems 100, 300, 400, 500 may be attached to a vehicle (e.g., tractor) that is operable to pull the thinning and weeding system 100, 300, 400, 500. For example, FIG. 11 displays the thinning and weeding system 100 attached to a tractor 109. The thinning and weeding systems 100, 300, 400, 500 may be attached to the tractor 109 via a three-point hitch or any other suitable attachment mechanisms known to a person skilled in the art. In the example of FIG. 11, the tractor 109 is controlled by an operator (e.g., who rides the tractor 109) using a wireless monitor (not shown) to control the thinning and weeding system 100 as the thinning and weeding system 100 travels along the beds 101 of plants 103. Accordingly, the operator of the tractor 109 may determine one or more of the various operational parameters (e.g., a travel speed) of the thinning and weeding system 100.

Thus, while a number of examples have been described for illustration purposes, the foregoing description is not intended to limit the scope of the invention, which is defined by the scope of the appended claims. There are and will be other examples and modifications within the scope of the following claims.

What is claimed is:

1. A method of selectively eradicating plants, comprising:
generating images of a plurality of plants arranged in a bed using a machine vision system mounted to a platform moving along the bed;
determining respective locations of the plurality of plants from the generated images;
selecting from among the plurality of plants one or more target plants to be eradicated; and
eradicating the one or more target plants by forcing the one or more target plants into the bed using a plunger moving along the bed.

2. The method of claim 1, wherein the machine vision system comprises at least one camera that is directed towards the bed and a processor that is operable to analyze the images.

3. The method of claim 1, wherein the machine vision system comprises at least one hood that surrounds the at least one camera.

4. The method of claim 1, further comprising identifying the plurality of plants in the generated images using a recognition algorithm.

5. The method of claim 1, wherein the plurality of plants comprises one or more of beets, carrots, lettuce, romaine, onions, parsnips, radishes, rutabagas, spinach, corn, and turnips.

6. The method of claim 1, wherein determining the respective locations of the plurality of plants comprises analyzing the generated images using a blog analysis algorithm.

7. The method of claim 1, wherein selecting the one or more target plants comprises comparing the respective locations of the plurality of plants to a predetermined spacing.

8. The method of claim 7, further comprising identifying one or more plants that are positioned within the predetermined spacing as the one or more target plants.

9. The method of claim 1, wherein eradicating the one or more target plants comprises pushing the one or more target plants about ½ inch to about 2 inches into the bed.

10. The method of claim 1, further comprising cutting the one or more target plants using the plunger.

11. The method of claim 10, wherein cutting the one or more target plants comprises severing one or more of leaves and stems of the one or more target plants.

12. The method of claim 1, further comprising identifying one or more weeds in the bed using a recognition algorithm.

13. The method of claim 12, further comprising:
cutting the one or more weeds using the plunger; and
eradicating the one or more weeds by forcing the one or more weeds into the bed using the plunger.

14. The method of claim 1, further comprising saving desired plants of the plurality of plants.

15. The method of claim 14, wherein saving desired plants comprises rotating the plunger around the desired plants.

16. The method of claim 15, wherein the plunger defines one or more gaps sized to surround a desired plant.

17. The method of claim 1, wherein the plunger is a rotary plunger comprising a base and multiple teeth that extend from an outer edge of the base.

18. The method of claim 17, wherein the multiple teeth are configured to cut the plurality of plants.

19. The method of claim 17, wherein the plunger is positioned at a height above the bed such that the plunger can push the one or more target plants into the bed as the plunger rotates.

20. The method of claim 17, wherein the base of the plunger defines one or more gaps sized to surround a desired plant.

21. The method of claim 1, wherein forcing the one or more target plants into the bed comprises dragging the plunger along the bed.

22. The method of claim 1, wherein forcing the one or more target plants into the bed comprises rotating the plunger as the plunger moves in the direction along the bed.

23. The method of claim 1, wherein the plunger is movable via a floating frame configured to move vertically as a function of a height of the surface of the bed.

24. The method of claim 22, wherein a vertical adjustment device is mounted to the floating frame, the vertical adjustment device supporting the plunger.

25. The method of claim 1, wherein forcing the one or more target plants into the bed comprises controlling a rotatory motor to rotate the plunger.

26. The method of claim 25, wherein prior to forcing the one or more target plants into the bed, the plunger is moved in a lateral direction by an actuator configured to translate the plunger.

27. The method of claim 1, wherein the images are generated, the respective locations of the plurality of plants are determined, the one or more target plants are selected, and the one or more target plants are eradicated, while the platform moves at a constant speed along the bed.

28. A plant eradication system, comprising:
a machine vision system that is configured to generate images of a plurality of plants arranged in a bed and determine respective locations of the plurality of plants while the plant eradication system is moved in a direction along the bed;
a controller that is configured to select one or more target plants from among the plurality of plants that should be eradicated, the controller being communicably coupled to the machine vision system; and
a plunger that is operable to eradicate the one or more target plants by forcing the one or more target plants into the bed as the plant eradication system is moved in the direction along the bed, the plunger being communicably coupled to the controller.
